(19) United States
(12) Patent Application Publication
(10) Pub. No.: US 2020/0214278 A1
(43) Pub. Date: Jul. 9, 2020

(54) Flexible-Fit Bottletop Plug Device for Trapping Insects

(71) Applicants: Ryan Stoller, Seattle, WA (US); Scott Stephan, Seattle, WA (US)

(72) Inventors: Ryan Stoller, Seattle, WA (US); Scott Stephan, Seattle, WA (US)

(21) Appl. No.: 16/736,723

(22) Filed: Jan. 7, 2020

Related U.S. Application Data
(60) Provisional application No. 62/789,578, filed on Jan. 8, 2019.

(51) Int. Cl. A01M 1/10; A01M 1/02

(52) U.S. Cl. CPC A01M 1/106; A01M 1/02

(57) ABSTRACT

A bottletop plug device for trapping flying insects. The bottletop plug device is a reversibly attachable accessory that converts a consumer-supplied narrow-neck bottle into a trap for flying insects. The plug device has a generally tapered body that includes a lower body segment and bottom tip insertable into a baited bottle, a middle body segment having a stack of resilient protruding circumferential ribs sealable against an inside wall of a bottle neck, and an upper body segment having a wide mouth entrance to an internal passageway or chamber that runs down the length of the body and through the bottom tip. At the bottom of the channel, a narrow “insect sized” orifice allows insects to have essentially one-way ingress into the bottle. The protruding ribs are circumferentially stacked like a stack of coins, but the stack is typically tapered top to bottom from greater diameter to lesser diameter so that the plug self-seatingly fits into and plugs various bottle neck sizes while allowing the central insect passageway to remain open. Alternatively the stack may be untapered. The bottle and bait may be supplied by the user.

### CROSS REFERENCE TO RELATED APPLICATIONS

This application claims the benefit of priority under 35 U.S.C. § 119(e) from US Provisional Patent Application No. 62/789,578 filed Jan. 8, 2019; said patent document being incorporated herein in entirety for all purposes by reference.

### TECHNICAL FIELD

The present disclosure relates to insect trap devices with an internal passageway surrounded by a flexible-fit stack of flexible ribs for insertion into a narrow neck bottle.

### BACKGROUND

Insects, and fruit flies in particular, are well-known pests in domestic and agricultural settings. Bottle traps have long been used for pest management and control. However, these solutions tend to have a single cap with mating bottle and hence require awkward or unsanitary efforts to prepare them for re-use.

Typically, the features of existing traps are such that mounting the cap onto the bottle requires a threaded or snap fastener. Having a threaded connection is slow and difficult to remove and the traps are not copacetic with the large number of bottles that have a narrow neck with smooth lipped opening. Snap fasteners are difficult to remove. In yet other trap devices, multi-component assemblies are employed, requiring disassembly and maintenance. Such devices are typically difficult to manufacture and are readily broken. Other options can require toxic or noxious chemicals, sticky paper, strips or handling of dead insects.

Thus, a need exists for a cost effective, more reliable, low maintenance solution. Needed is a way to use any narrow-neck bottle as a trap and subsequently dispose of captured flies or insects. In more particularity, it would be desirable to provide a convenient way to repurpose or recycle consumer-supplied bottles for capturing nuisance insects while also permitting easy disposal of entrapped flies or insects.

### SUMMARY

A bottletop plug device is provided that is flexibly press fit into a narrow-neck opening of a consumer-supplied bottle so as to convert the bottle into a trap for flying insects. The bottle may be disposable but the plug device is reusable.

Various embodiments of the bottletop plug device (here “plug device” or “device”) comprise a silicon (or otherwise flexible polymer) body that inserts into the mouth of a narrow-neck bottle. By providing a stack 11 of circumferential ribs on the silicon body, the plug device is adapted for use with a variety of bottles commonly used by consumers for liquid product transportation and storage, such as, for example, conventional wine, beer and most other disposable or recyclable bottles utilized for drink consumption. In some embodiments, the plug device provides a discreet and convenient structure and method for fruit fly abatement which can be realized based on low production costs. A consumer utilizing a plug device of the present disclosure can reduce waste in comparison with a disposable trap, and is spared any messy cleaning maintenance.

In some embodiments, the plug device of the present disclosure provides for easy installation and removal from a compatible bottle. The pliability of the silicone/flexible polymer material used provides versatility, durability and ensures airtight seal around the perimeter of the plug-style trap. An opening in the center of the device allows fruit flies to enter the bottle, while the size and shape of the opening entraps the flies and efficiently prevents escape.

One size fits all. The bottletop plug devices are adapted to reusably convert a user-supplied narrow-neck bottle into an insect trap and the capacity of the plug devices to be inserted into narrow necks of varying diameter bottle openings allows the user to exchange the bottle periodically with any of a range of bottle sizes. Bottles that have been used can be discarded and a new bottle selected because the flexible plug device is designed to work with any of a range of bottle neck sizes.

Generally, the plug devices may be characterized as having a flexible body which tapers as it extends downwardly from a top of the body, a lower portion or segment of the body defining a bottom tip, an intermediate portion or segment of the body defining a plurality of laterally protruding sealing members, and an internal conduit chamber extending from an opening at the top of the body to an insect-sized orifice that defines an insect ingress portal from the bottom tip when the device is seated in a narrow-neck bottle; wherein the body is configured to be press fit into the bottle neck and the plurality of protruding sealing members are configured such that at least one of the protruding sealing members sealingly seats against the inside wall of the neck.

More generally, the devices possess a flexible body with body sidewall that extends downwardly from an upper portion at the top of the body, a lower portion of the body that defines a bottom end, an intermediate portion of the body with plurality of laterally protruding seal members disposed on the sidewall, and an internal conduit chamber that extends from an opening at the top of the body to an insect-sized orifice that defines an exit from the internal conduit chamber through the bottom end; wherein the bottom end is configured to be press fit into the neck of a narrow-necked bottle and the plurality of protruding sealing members are configured such that at least one of the protruding sealing members is sealingly contactable with an inside wall of the neck of a bottle.

The body sidewall may taper as it extends downwardly from an upper lip at the top of the body. The laterally protruding seal members protrude axisymmetrically from the body sidewall and may be a tapered stack of circumferential ribs, the plurality of circumferential ribs having an uppermost circumferential rib of a first diameter and at least one lower circumferential rib of a lesser diameter. Alternatively, the body sidewall may be cylindrical as it extends downwardly from an upper lip at the top of the body. The laterally protruding seal members may protrude axisymmetrically from the body sidewall and may be an untapered stack of circumferential ribs, each of the circumferential ribs having essentially the same diameter.

In some embodiments, the internal conduit chamber is bounded by a body sidewall or funnel sidewall that defines an open widemouth at a top of the body and an insect-sized orifice at a bottom of the body such that the internal conduit chamber fluidly connects the open widemouth and the insect-sized orifice. Conceptually, the body may have three joined segments: (a) an upper body segment disposed at the top of the body, wherein the upper body segment is defined by the open widemouth and a widemouth lip surrounding the open widemouth; (b) a middle body segment disposed below the upper body segment, wherein the middle body segment is defined by a plurality of circumferential rib members that protrude axisymmetrically from the body sidewall, the plurality of circumferential rib members having an upper circumferential rib of a first diameter and at least one lower circumferential rib of a lesser diameter; and, (c) a lower body segment disposed below the middle body segment, wherein the lower body segment is defined by a bottom tip with insect-sized orifice, wherein the bottom tip is adapted to be inserted into an opening of a narrow-neck bottle such that at least one of the plurality of circumferential rib members of the middle body segment is sealingly contactable with an inside surface of a bottle neck when the open widemouth is in open fluid connection with the inside volume of a bottle via the internal conduit chamber.

In some instances, the lower body segment comprises a first taper continuous with the outside taper of the body sidewall and a bottom tip having a second taper, the tip defining an inside wall and an outside wall of the narrow orifice at the bottom of the body, wherein the second taper is greater than the first taper and the tip is adapted to be inserted into an open narrow-neck bottle such that the outside wall of the tip is centered in and is not in contact with the inside surface of the bottle, and at least one of the plurality of circumferential rib members is sealingly contacted with the inside surface of the bottle, whereby the open widemouth is fluidly connected to the inside of the bottle via the center chamber.

The elements, features, steps, and advantages of one or more embodiments will be more readily understood upon consideration of the following detailed description, taken in conjunction with the accompanying drawings, in which embodiments, including details, conceptual elements, and current practices, are illustrated by way of example.

It is to be expressly understood, however, that the drawings are for illustration and description only and are not intended as a definition of the limits of the embodiments and conceptual basis as claimed. The various elements, features, steps, and combinations thereof that characterize aspects of the claimed matter are pointed out with particularity in the claims annexed to and forming part of this disclosure. The invention(s) do not necessarily reside in any one of these aspects taken alone, but rather in the invention(s) taken as a whole.

### BRIEF DESCRIPTION OF THE DRAWINGS

One or more embodiments are taught and are more readily understood by considering the drawings in association with the specification, in which:

FIG. 1a is a top isometric view of the plug device for some embodiments of the present disclosure.

FIG. 1b is a bottom isometric view of the plug device of FIG. 1.

FIG. 2 is a side elevation view thereof.

FIG. 3 is a top plan view thereof.

FIG. 4 is a bottom plan view thereof.

FIG. 5 is a side cross sectional view thereof, along line FIG. 5-FIG. 5 in FIGS. 3 and 4.

FIG. 6 shows a side view of a plug device having rounded circumferential ribs.

FIG. 7 is a picture a completed trap assembly with plug device inserted in the neck of a bottle and bait in the bottom of the bottle.

FIG. 8 is a close-up picture of a neck portion of a bottle with the plug device in its position of use.

FIGS. 9A, 9B, 9C and 9D are side, top, perspective and bottom views respectively of an alternate embodiment of a plug device.

FIGS. 10A, 10B, 10C and 10D are side, top, perspective and bottom views respectively of an alternate embodiment of a plug device.

FIGS. 11A, 11B, 11C and 11D are side, top, perspective and bottom views respectively of an alternate embodiment of a plug device.

FIGS. 12A, 12B, 12C and 12D are side, top, perspective and bottom views respectively of an alternate embodiment of a plug device.

FIGS. 13A, 13B, and 13C are side views of alternate embodiments of plug devices having five, four and six circumferential ribs respectively.

FIGS. 14A, 14B, 14C and 14D are side, top, perspective and bottom views respectively of an alternate embodiment of a plug device.

FIGS. 15A, 15B, 15C and 15D are side, top, perspective and bottom views respectively of an alternate embodiment of a plug device having an untapered body and parallel circumferential rib profile.

FIGS. 16A, 16B, 16C and 16D are side, top, perspective and bottom views respectively of an alternate embodiment of a plug device having a tapered upper body and untapered circumferential rib profile.

FIGS. 17A, 17B, 17C, 17D and 17E are assembly, section, top, side and bottom views respectively of an embodiment of a plug device having an external sheath for engaging a mouth of a narrow-neck bottle.

The drawing figures are not necessarily to scale. Certain features or components herein may be shown in somewhat schematic form and some details of conventional elements may not be shown in the interest of clarity, explanation, and conciseness. The drawing figures are hereby made part of the specification, written description and teachings disclosed herein.

### GLOSSARY

Certain terms are used throughout the following description to refer to particular features, steps, or components, and are used as terms of description and not of limitation. As one skilled in the art will appreciate, different persons may refer to the same feature, step, or component by different names. Components, steps, or features that differ in name but not in structure, function, or action are considered equivalent and not distinguishable, and may be substituted herein without departure from the spirit and scope of the disclosure. The following definitions supplement those set forth elsewhere in this specification. Certain meanings are defined here as intended by the inventors, i.e., they are intrinsic meanings. Other words and phrases used herein take their meaning as consistent with usage as would be apparent to one skilled in the relevant arts. In case of conflict, the present specification, including definitions, will control.

A “segment” of a body is a portion of the solid body having a function and geometric features corresponding to that function, and as used here, the solid body of a plug device may be divided conceptually into a top body segment, a middle or intermediate body segment, and a lower body segment.

As used herein, the terms “include” and “comprise” are used synonymously, the terms and variants of which are intended to be construed as non-limiting. The definitions in this paragraph are intended to apply throughout this disclosure unless otherwise expressly stated.

General connection terms including, but not limited to “connected,” “attached,” “conjoined,” “secured,” and “affixed” are not meant to be limiting, such that structures so “associated” may have more than one way of being associated. “Fluidly connected” indicates a connection for conveying a fluid therethrough. “Digitally connected” indicates a connection in which digital data may be conveyed therethrough. “Electrically connected” indicates a connection in which units of electrical charge are conveyed therethrough.

In the present disclosure, to the extent the terms “about” and “approximately,” are used, they mean ±20% of the indicated range, value, or structure, unless otherwise indicated. In the present description, the terms “a” and “an” as used herein refer to “one or more” of the enumerated components. The use of the alternative (e.g., “or”) should be understood to mean either one, both, or any combination thereof of the recited alternatives.

Relative terms should be construed as such. For example, the term “front” is meant to be relative to the term “back,” the term “upper” is meant to be relative to the term “lower,” the term “vertical” is meant to be relative to the term “horizontal,” the term “top” is meant to be relative to the term “bottom,” and the term “inside” is meant to be relative to the term “outside,” and so forth. Unless specifically stated otherwise, the terms “first,” “second,” “third,” and “fourth” are meant solely for purposes of designation and not for order or for limitation. Reference to “one embodiment,” “an embodiment,” or an “aspect,” means that a particular feature, structure, step, combination or characteristic described in connection with the embodiment or aspect is included in at least one realization of the inventive matter disclosed here. Thus, the appearances of the phrases “in one embodiment” or “in an embodiment” in various places throughout this specification are not necessarily all referring to the same embodiment and may apply to multiple embodiments. Furthermore, particular features, structures, or characteristics of the inventive matter may be combined in any suitable manner in one or more embodiments. For example, it is contemplated that features of dependent claims depending from one independent claim can be used in apparatus and/or methods of any of the other independent claims.

“Adapted to” includes and encompasses the meanings of “capable of” and additionally, “designed to”, as applies to those uses intended by the patent. In contrast, a claim drafted with the limitation “capable of” also encompasses unintended uses and misuses of a functional element beyond those uses indicated in the disclosure. Aspex Eyewear v Marchon Eyewear 672 F3d 1335, 1349 (Fed Circ 2012). “Configured to”, as used here, is taken to indicate is able to, is designed to, and is intended to function in support of the inventive structures, and is thus more stringent than “enabled to”.

It should be noted that the terms “may,” “can,” and “might” are used to indicate alternatives and optional features and only should be construed as a limitation if specifically included in the claims. The various components, features, steps, or embodiments thereof are all “preferred” whether or not specifically so indicated. Claims not including a specific limitation should not be construed to include that limitation. For example, the term “a” or “an” as used in the claims does not exclude a plurality.

“Conventional” refers to a term or method designating that which is known and commonly understood in the technology to which this disclosure relates.

The appended claims are not to be interpreted as including means-plus-function limitations, unless a given claim explicitly evokes the means-plus-function clause of 35 USC § 112 para (f) by using the phrase “means for” followed by a verb in gerund form.

A “method” as disclosed herein refers to one or more steps or actions for achieving the described end. Unless a specific order of steps or actions is required for proper operation of the embodiment, the order and/or use of specific steps and/or actions may be modified without departing from the scope of the present disclosure.

### DETAILED DESCRIPTION

In the present description, certain specific details are set forth in order to provide a thorough understanding of various embodiments of the disclosure. However, upon reviewing this disclosure one skilled in the art will understand that the various embodiments disclosed herein may be practiced without many of these details. In other instances, some well-known structures and materials of construction have not been described in detail to avoid unnecessarily obscuring the descriptions of the embodiments of the disclosure.

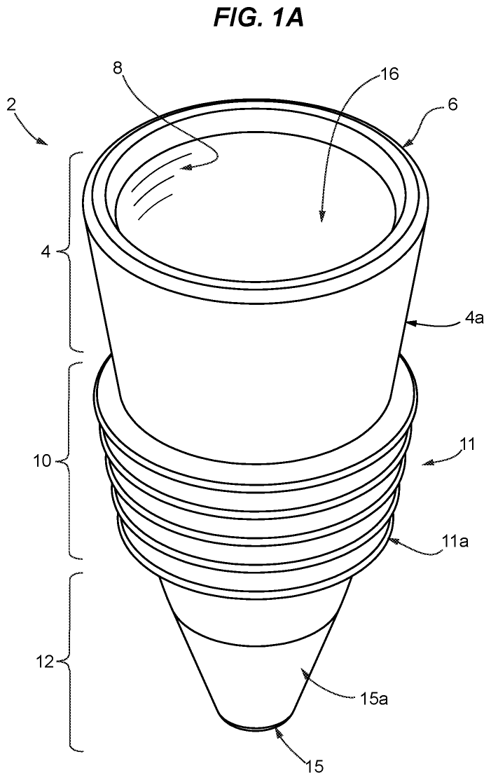

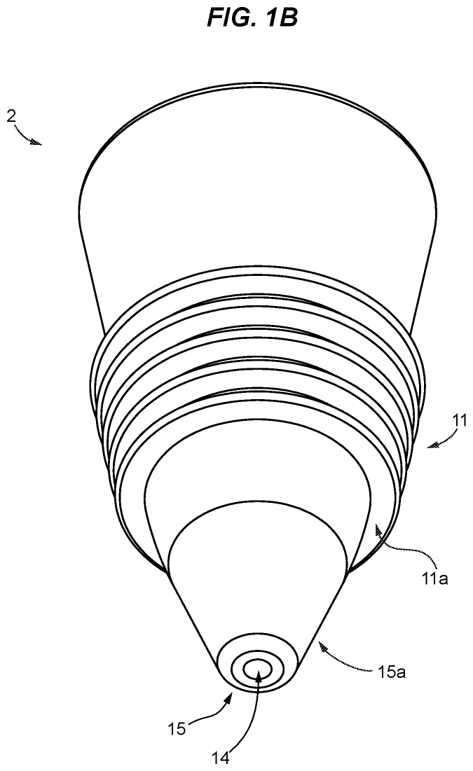

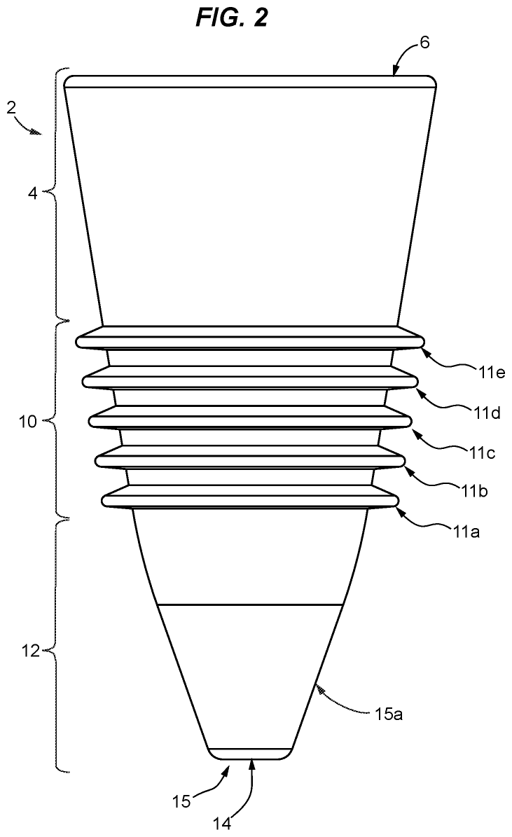

FIGS. 1A and 1B are perspective views of a plug device, according to a first embodiment. FIG. 2 is an elevation view, and FIGS. 3 and 4, respectively, are top and bottom plan views. Referring to FIGS. 1A through 7, shown are views of a “plug device” 2 (or “plug member”) suitable for use with a bottle 26 having a neck 24 with lip 20 and an inside wall 20a (FIG. 8). The plug device 2 can be made of silicone or other polymeric materials with similar characteristics, imparting the plug device with resiliency. That is, the plug device 2 can be made of any suitable material such that it can be compressed to conform to the shape of a given bottle neck and lip, to be contacted sealedly with an interior wall portion thereof, and to return to its original molded shape when removed.

In a preferred use, the plug device is effective in converting a consumer supplied narrow-neck bottle into a trap for capturing flying insects, particularly fruit flies. Fruit flies breed in fruit and in kitchen garburators, and are attracted to ripening fruit and to garbage storage areas. The bottle used with the plug device is baited before use, and the plug device is inserted like a cork into the top of the bottle. The vertical stack of circumferential ribs 11 seals against the inside of the bottle and the open center channel acts as a funnel to guide fruit flies into the bottle. Once the flies enter the trap, they cannot escape to continue breeding and multiplying. The traps are safety used in kitchens, restaurants, bars, for example. The plug devices may be made of high quality food grade silicone materials and are generally washable and reusable. The bottle also can be reused if desired, after cleaning with water or can be disposed of with any flies that are trapped. The plug devices may be designed to fit an assortment of repurposed narrow-necked bottles, including most glass wine, beer, soda, or water bottles.

In use, the device is press fit into the narrow neck of a disposable bottle until at least one circumferential rib of a stack of circumferential ribs of tapered diameters sealingly seats against the inside wall of the neck of the bottle. The small bottom orifice allows flying insects to enter and prevents escape.

As shown in FIG. 1A, the plug device includes an upper body segment 4 and a lower body segment (12) separated by a ribbed middle body segment 10. The lower body segment inserts into a bottle and one or more ribs 10a of the middle body segment 10 engage the lip 20 and/or inside wall 20a of the bottle 20 (FIG. 8). The middle body segment includes a vertical stack 11 of circumferential ribs of tapered diameters, at least one circumferential rib of which will self-seat on the inside wall of a wide-mouth body neck when press fit into the opening. The ribs are generally stacked in spaced apart fashion.

In a preferred embodiment, the upper body segment is defined by a generally conical sidewall with “widemouth” top opening into a generally conical receiving orifice or “chamber” 16 inside. The chamber 16 narrows in the lower body section to form an open passage for flying insects through the funnel and out a bottom orifice 14 (FIG. 2) at the base 15 into a bottle. When the plug device is inserted into a compatible bottle and baited, insects that go through the bottom orifice are prevented from leaving the bottle by the narrowness of bottom orifice 14 as positioned on the tapered trap bottom tip 15, and by the circumferential ribs 11. In some embodiments, the internal channel 16 has the shape of a funnel that can have a tapered inside wall or can have a cylindrical inside wall.

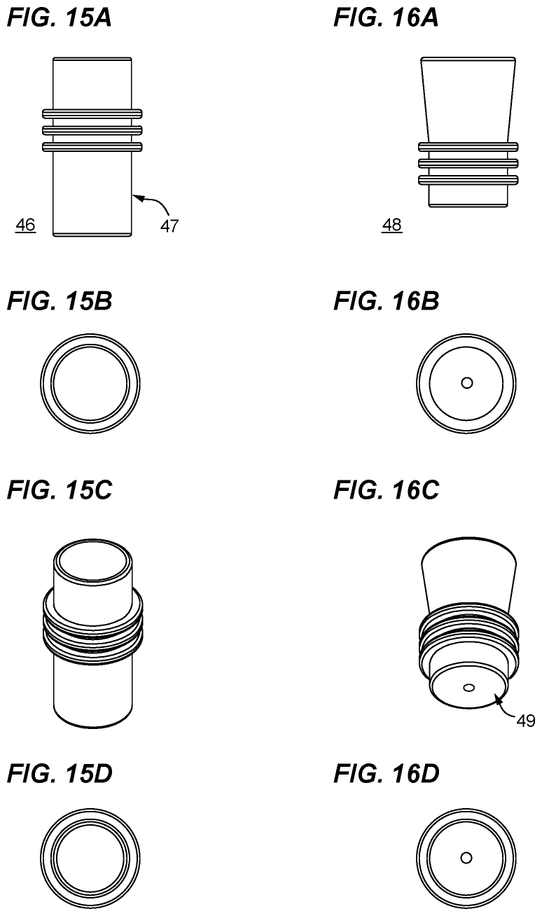

The stack 11 of compressible ribs can be said to taper in descending diameter from rib 11e through rib 11a. In this way, the plug body seal is self-seating when press fit into a narrow-neck bottle. In other embodiments, the stack of ribs may be untapered on a tapered or an untapered body (FIGS. 15A-16D).

As shown in FIG. 3, the upper body segment 4 comprises a conical sidewall 4a enclosing an internal chamber 16. The conical sidewall 4a can be said to begin at a top body segment of the device 2 in the form of a lip 6, defines an opening with inside wall 8 into a conical chamber 16, and extends downward in a tapering manner to a lower body segment 12. The internal circumference of the chamber 16 generally tapers from the lip 6 to the bottom orifice 14. The conical sidewall 4a has an inner surface 8 forming the surface perimeter of the chamber 16 that tapers inward in the accordance with the conical sidewall 4a. In some embodiments, the conical sidewall 4a can be of generally constant thickness. The conical sidewall also has an outer surface, with a circumference that narrows in generally linear fashion starting from the lip portion 6 to the ribbed middle body segment 10. The overall body from top to bottom can taper smoothly, stepwise, can be tapered by varying degree, some parts of the wall sections tapering gradually, other parts of the wall sections tapering sharply, or can be untapered.

As drawn, the overall body shape is generally conical in shape, but the taper of the outside walls may be varied. According to one embodiment, the lower body segment 12 is disposed below and joined to the middle body segment and terminates in the bottom tip. At the junction, the lower body segment has a first taper continuous with the outside taper of the body sidewall, but the taper may be increased at the bottom tip. In various embodiments, the bottom tip 15 may have a second taper 15a, the tip defining an inside wall and an outside wall of the narrow orifice 14 at the bottom of the body, in which the second taper angle 15a is greater than the first taper angle and the bottom tip 15 is adapted to be inserted into an open narrow-neck bottle such that the outside wall of the tip is centered in and is not in contact with the inside surface of the bottle and at least one of the plurality of circumferential rib members in the stack 11 is sealingly contacted with the inside surface of the bottle. In this way, the open widemouth is fluidly connected to the inside of the bottle via the center chamber and fruit flies entering the trap encounter little or no resistance. But once trapped, fruit flies ascending the bottle encounter a dead end where the bottom tip wall separates from the bottle wall.

In other embodiments, the middle body segment ends without a well-defined lower body segment and the insect-sized orifice is formed at about or slightly below the level of the lowest of the protruding sealing members that extend from the body sidewall.

In some embodiments, the inner and outer surfaces of the conical sidewall 4a do not converge at the lower body segment 12, but instead, the conical sidewall 4 terminates at a defined tip 15 before convergence, leaving a space between inner surface portions of the conical sidewall 4 at a bottom of the plug device 2, between which is a bottle-ingress orifice 14 (see, e.g., FIG. 5). In some embodiments, the body sidewall 4 defines the inner surface portions of the conical sidewall 4 at a bottom of the plug device 2, and an orifice 14 is provided on that bottom tip 15.

In any case, the internal chamber 16 therefore provides a pathway for a fly or other insect starting from the widemouth lip 6 to the bottle-ingress orifice 14, through which the fly or other insect can pass into a bottle or other container to which the plug device 2 is connected.

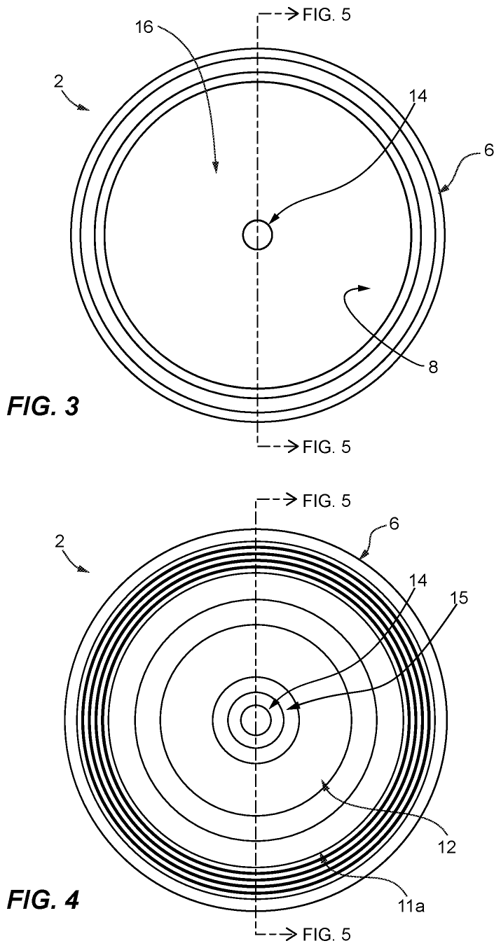

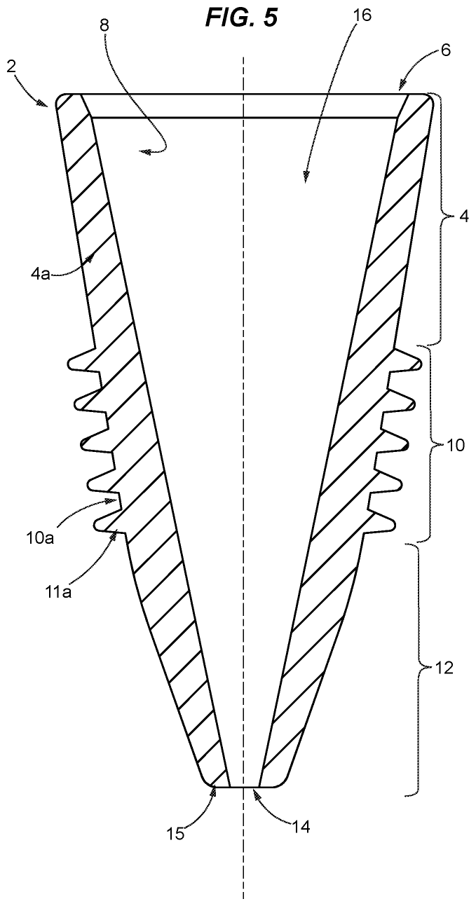

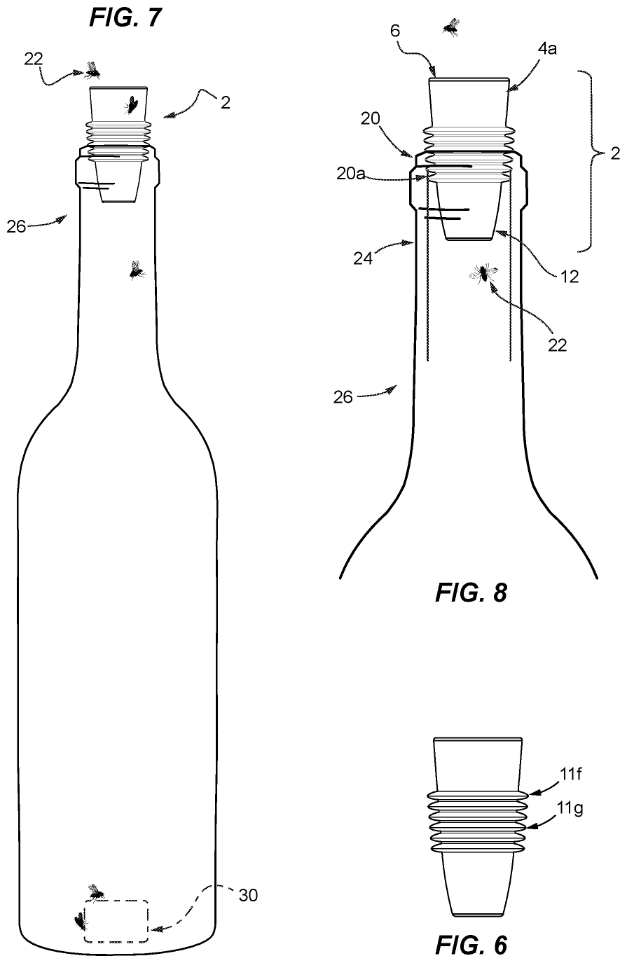

FIG. 6 shows a side view of a plug device having a rounded circumferential rib 11f and a stack 11 below that of ribs of descending diameter. The profile of each rib is modified from earlier views and includes a more prominent radius of curvature. In this embodiment, a stack 11 of five circumferential ribs, each smaller than the one above, is flexibly insertable into a narrow-neck of a bottle so that the plug device naturally finds a level in which there is no looseness. In a narrow bottle, circumferential rib 11g of lesser diameter may form a plug fit; but in a larger narrow-neck bottle, circumferential rib of greater diameter 11f may form a plug fit, and by this means the device is self-seating on a variety of bottles supplied by the consumer, according to one embodiment.

FIG. 7 is a picture a completed insect trap assembly with plug device 2 inserted in the neck of a bottle 26 and bait 30 in the bottom of the bottle. In use, the plug device 2 is inserted into a bottle 26, as can be seen in FIG. 8 via press fit, to activate a seal. The lower body segment 12 of the plug device 2 can be more narrow than the lip 20 on the neck 24 of the bottle 26, and therefore is insertable into the bottle mouth or opening, and is made of a resilient material that is compressible to fit snugly and be self-seating at a level at which one of the circumferential ribs of the middle body segment rests on the lip of the bottle and one or more ribs are wedged inside the bottle opening. The plurality of circumferential ribs 11 (protruding sealing rib members 11a, 11b, 11c, 11d, 11e) are also resilient and/or compressible with spring characteristics. The rib members are vertically spaced apart along the vertical axis of the device body 2, just above the lower body segment 12. The compressible nature of the tapered lower body segment 12 combined with the resilient flexible circumferential ribs 10, provides for a reliable press fit seal against an inner surface 20a of the neck 24 of the bottle 26 when a user presses the lower body segment 12 into the mouth of the bottle to attach the plug device thereto. Use of a series of compressible ribs, each smaller than the one above, for example, allows a range of bottle sizes to be used with the plug device.

The ribbed middle body segment 10 may have one or more circumferential ribs 11. Depending on the internal dimensions of the bottle neck and the taper of the plug device body, the circumferential ribs will typically have differing diameters to fit different bottle neck sizes. By engaging the plug device to the bottle with a press fit, the rib most effective in sealing the plug body will seat itself in place. Some plug device bodies may have four circumferential ribs, others three, others five, six, and so forth. Devices with just two circumferential ribs are also contemplated.

Thereafter, the wide mouth opening 8 at the top of the conical body 2, defined by widemouth opening lip 6, allows for vapors from bait 30 (placed within the bottle as best seen in FIG. 8) to be vented such that a scent emanates from the bottom, thereby attracting flies. Flies are admitted into the trap through the internal chamber 16 and by way of orifice 14 at the bottom tip 15 of the chamber 16. Since the orifice 14 is narrow (smaller circumference) and more constricted than the widemouth entry opening 8, the rate at which any flies can leave the bottle is substantially less than the rate at which they enter, minimizing the risk of the flies exiting the bottle. For clarity, the size of orifice 14 may be described as “insect sized” to indicate that the orifice is configured with a minimal diameter just sufficient so that insect bodies may pass through the opening.

FIG. 8 is a close-up picture of a neck portion of a bottle with the plug device in its position of use. Fruit flies are attracted to aging and spoiled fruit. Using their keen sense of smell, the fruit flies smell gases released from aging fruit and are attracted so that they enter into the bottle through the plug device orifice 14. Once the flies enter the bottle, they cannot escape. Bits of banana or banana skin may be used as bait, for example. Wine, beer, cider vinegar, or bits of fruit also may be used to bait the trap.

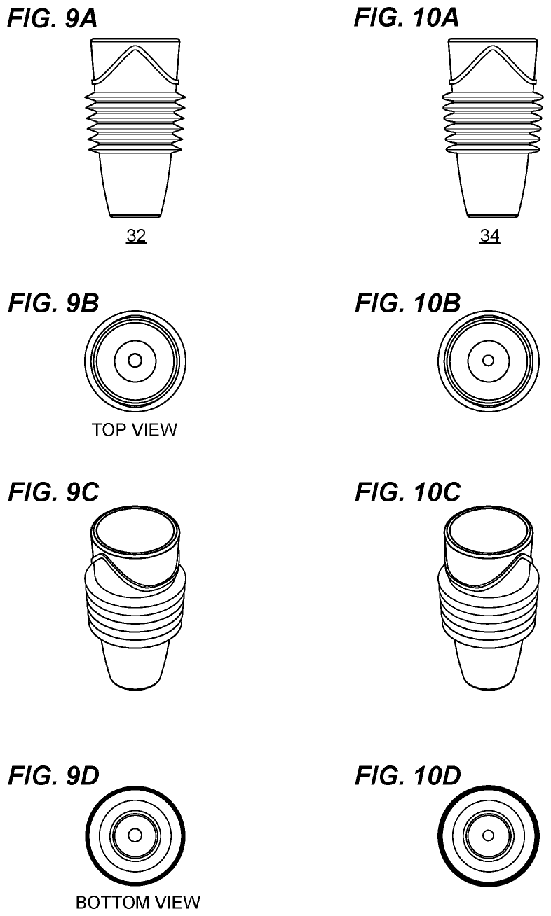

FIGS. 9A, 9B, 9C and 9D are side, top, perspective and bottom views respectively of an alternate embodiment of a plug device 32. The plug device includes a decorative feature on the conical sidewall. Other decorative features may be used. Texture to facilitate handling may also be introduced, but generally the features are designed with a utilitarian eye to ensuring the plug devices are easy to clean. The alternate plug device depicted here may be fitted to a variety of bottle narrow-neck sizes for use as an insect trap.

FIGS. 10A, 10B, 10C and 10D are side, top, perspective and bottom views respectively of an alternate embodiment of a plug device 34.

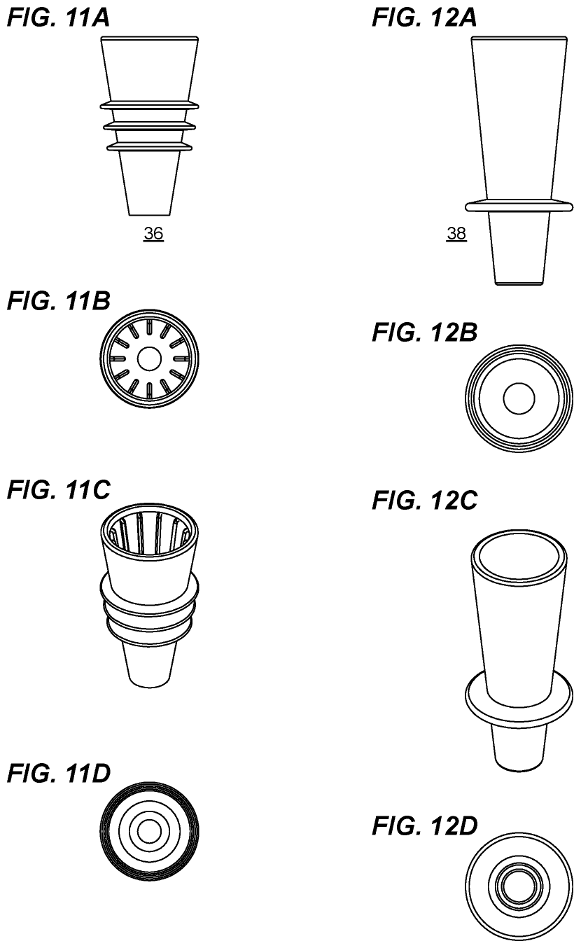

FIGS. 11A, 11B, 11C and 11D are side, top, perspective and bottom views respectively of an alternate embodiment of a plug device 36. In this embodiment, internal ribs are provided.

FIGS. 12A, 12B, 12C and 12D are side, top, perspective and bottom views respectively of an alternate embodiment of a plug device 38, the plug device having one circumferential rib and an extended body.

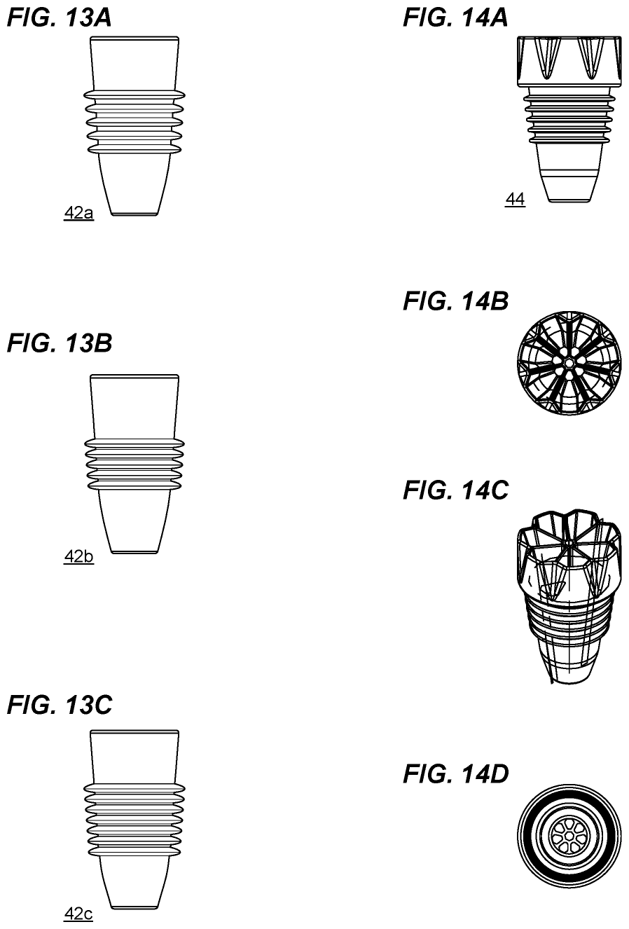

FIGS. 13A, 13B, and 13C are side views of alternate embodiments of plug devices having five (42a), four (42b) and six (42c) circumferential ribs.

FIGS. 14A, 14B, 14C and 14D are side, top, perspective and bottom views respectively of an alternate embodiment of a plug device 44. The plug device is distinguished by a rosette of funnel elements that provide ingress into the bottle.

FIGS. 15A, 15B, 15C and 15D are side, top, perspective and bottom views respectively of an alternate embodiment of a plug device 46 having an untapered body 47 and parallel circumferential rib profile. In this instance, the body may be described as having a cylindrical sidewall. In some alternative embodiments a cylinder is provided having stepped walls.

FIGS. 16A, 16B, 16C and 16D are side, top, perspective and bottom views respectively of an alternate embodiment of a plug device 48 having a tapered body and untapered circumferential rib profile with a generally flat bottom end 49.

While not shown, in some instances the upper body segment may have an untapered sidewall and have an inside cylindrical funnel and the ribs may be tapered or untapered. The untapered sidewall of the upper body segment may have a diameter of the greatest diameter of the circumferential ribs so that it seats above and on the lip of the bottle neck, whereas the remaining ribs may be tapered or have a smaller diameter on an intermediate or lower body segment having a tapered or untapered body with a smaller diameter than the outside diameter of the ribs.

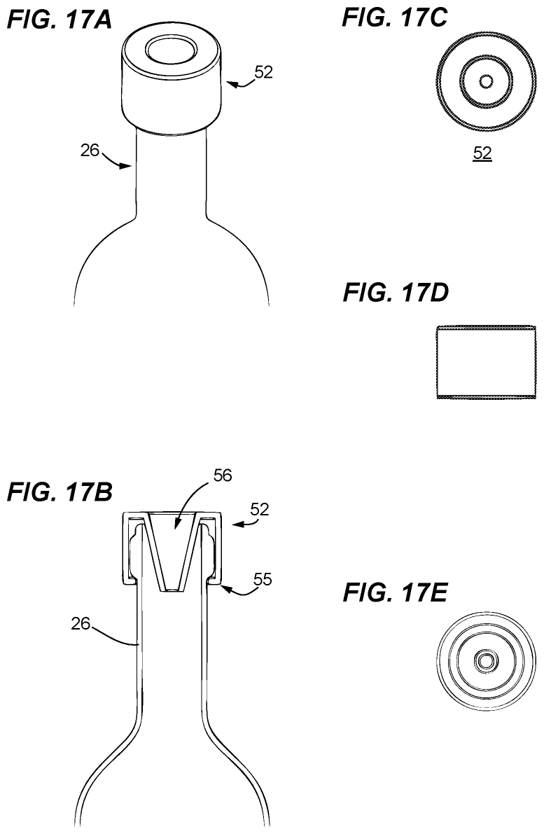

FIGS. 17A, 17B, 17C, 17D and 17E are assembly, section, top, side and bottom views respectively of an embodiment of a plug device 52 having an external sheath for engaging a mouth of a narrow-neck bottle. FIG. 17B shows the plug device in section view so that the external sheath 55 and internal chamber 56 with wall are identifiable. The exterior coupling sheath 55 seals the bottle by enveloping the exterior of the bottle's neck (FIG. 17B). In FIGS. 17A and 17B, the trap is shown assembled on a narrow-neck bottle 26.

In some embodiments, the plug device body is made to have an orange or a yellow color, both of which have been scientifically proven to attract fruit flies [Greany P D et al. 1977, Field studies on color preferences of the Caribbean fruit fly, Entomol Exp Applicata https://doi.org/10.1111/j.1570-7458.1977.tb02657.x; Marmaini A and D W Saputra, 2016, Trap color effects of fruit flies in cropping lime village. Intl Res J Natural Sci 4:1-14]. In another embodiment, the interior walls or lip of the widemouth funnel are orange or yellow to promote migration of the flies into the trap in response to a vapor gradient released by the bait.

This could be constructed as single structure or a multi-part structure. Larger or smaller versions are conceived to pair with a range of containers. Length and height of the device may be adjusted for the purposes of utility or aesthetics. This style of trap could also be employed for capturing other insects, such as mosquitos. In the case of mosquitos, carbon dioxide vapor (from “dry ice”) is useful as bait and the chamber through the plug body is necessarily “insect sized” and proportioned to the size of the mosquito.

Also disclosed are methods useful in trapping nuisance insects with a plug device and a baited narrow-neck bottle. In a first instance, a method of trapping fruit flies can consist of supplying a flexibly-fittable plug device as drawn and disclosed here; instructing a user to insert the body tip into a compatible bottle after baiting the bottle. In general, the insertable body segment of the plug device is tapered so as to be engageable inside a range of bottle neck sizes. In practice, the device may be provided with instructions, the instructions generally will comprise instructing a consumer or user to press fit the body of the bottletop plug device into the mouth of a narrow-necked bottle (the narrow-necked bottle to be supplied by the user) the bottletop plug device having a widemouth open top defined by a top lip of the device, an internal chamber connecting the widemouth open top to an insect-sized bottom orifice at the bottom tip of the device, and a middle body segment with a plurality of pliant protruding circumferential ribs for sealing the device against the inside walls of the bottle neck after baiting the bottle After baiting the bottle, the method may include instructions for abutting a circumferential rib against the inside wall of the neck of a bottle so as to form a seal, where the circumferential rib diameter is self-seated, and the abutting rib is one of a plurality of circumferential ribs disposed in ascending diameter on the tapered body of the plug device (2, 32, 34, 36, 38, 42a, 42b, 42c, 44). Generally, the smallest rib that effects a seal is sufficient to seat the device. In devices having untapered ribs, one rib will seal above another.

In another instance, the method comprises supplying a bottletop plug device of this disclosure, the bottletop plug device having a body with widemouth open top defined by a top lip of the device, an internal conduit chamber fluidly connecting the widemouth open top to an insect-sized bottom orifice at the bottom end of the device, a plurality of laterally protruding seal members intermediately disposed on the device body, the seal members defining a stack of circumferential ribs.

The various embodiments described herein, are presented as non-limiting example embodiments of the present disclosure, unless otherwise expressly indicated. With an understanding of the present disclosure, an individual of ordinary skill in the art will immediately appreciate that some details and features can be added, removed and/or changed without deviating from the spirit of the disclosure. Reference throughout this specification to “various embodiments,” “one embodiment,” “an embodiment,” “additional embodiment(s)”, “alternative embodiments,” or “some embodiments,” means that a particular feature, structure or characteristic described in connection with the embodiment(s) is included in at least one or some embodiment(s), but not necessarily all embodiments, such that the references do not necessarily refer to the same embodiment(s). Furthermore, the particular features, structures, or characteristics may be combined in any suitable manner in one or more embodiments. These and other changes can be made to the embodiments in light of the above-detailed description. In general, in the following claims, the terms used should not be construed to limit the claims to the specific embodiments disclosed in the specification, but should be construed to include all possible embodiments along with the full scope of equivalents to which such claims are entitled. Accordingly, the claims are not limited by the disclosure.

Throughout the description, where articles and apparatus are described as having, including, or comprising specific components, or where processes and methods are described as having, including, or comprising specific steps, it is contemplated that, additionally, there are articles and apparatus that consist essentially of, or consist of, the recited components, and that there are processes and methods that consist essentially of, or consist of, the recited processing steps.

It should be understood that the order of steps or order for performing certain actions is immaterial if the embodiment remains operable. Moreover, two or more steps or actions may be conducted simultaneously.

### INCORPORATION BY REFERENCE

All of the U.S. Patents, U.S. Patent application publications, U.S. Patent applications, foreign patents, foreign patent applications and non-patent publications referred to in this specification and related filings are incorporated herein by reference in their entirety for all purposes.

### SCOPE OF THE CLAIMS

The disclosure set forth herein of certain exemplary embodiments, including all text, drawings, annotations, and graphs, is sufficient to enable one of ordinary skill in the art to practice the invention. Various alternatives, modifications and equivalents are possible, as will readily occur to those skilled in the art in practice of the invention. The inventions, examples, and embodiments described herein are not limited to particularly exemplified materials, methods, and/or structures and various changes may be made in the size, shape, type, number and arrangement of parts described herein. All embodiments, alternatives, modifications and equivalents may be combined to provide further embodiments of the present invention without departing from the true spirit and scope of the invention.

In general, in the following claims, the terms used in the written description should not be construed to limit the claims to specific embodiments described herein for illustration, but should be construed to include all possible embodiments, both specific and generic, along with the full scope of equivalents to which such claims are entitled. Accordingly, the claims are not limited in haec verba by the disclosure.

What is claimed is:

1. A bottletop plug device adapted to reusably convert a user-supplied narrow-neck bottle into an insect trap, the plug device comprising:
a flexible body with body sidewall that extends downwardly from an upper portion at the top of the body, a lower portion of the body that defines a bottom end, an intermediate portion of the body with a plurality of laterally protruding seal members disposed on the sidewall, and an internal conduit chamber that extends from an opening at the top of the body to an insect-sized orifice that defines an exit from the internal conduit chamber through the bottom end; wherein the bottom end is configured to be press fit into the neck of a narrow-necked bottle and the plurality of protruding seal members are configured such that at least one of the protruding seal members is sealingly contactable with an inside wall of the neck of a bottle.

2. The bottletop plug device of claim 1, wherein the body sidewall tapers as it extends downwardly from an upper portion at the top of the body.

3. The bottletop plug device of claim 1, wherein,
(a) the upper portion of the body comprises a widemouth open to the internal conduit chamber and a widemouth lip surrounding the widemouth;
(b) the laterally protruding seal members are circumferential rib members that protrude axisymmetrically from the body sidewall and are disposed in a stack; and,
(c) the bottom end comprises a bottom tip adapted to be inserted into an opening of a narrow-neck bottle such that at least one of the stack of circumferential ribs is sealingly contactable with an inside wall of a bottle neck when the widemouth is in open fluid connection with the inside volume of the bottle via the internal conduit chamber and the insect-sized orifice.

4. The bottleneck plug device of claim 1, wherein the laterally protruding seal members are circumferential ribs that protrude axisymmetrically from the body sidewall as a tapered stack of circumferential ribs, the plurality of circumferential ribs having an uppermost circumferential rib of a first diameter and at least one lower circumferential rib of a lesser diameter.

5. The bottletop plug device of claim 1, wherein the laterally protruding seal members are circumferential ribs that protrude axisymmetrically from the body sidewall, each of the circumferential ribs having essentially the same diameter.

6. The bottletop plug device of claim 1, wherein the insect-sized orifice at the bottom of the body is configured for receiving a fruit fly.

7. The bottletop plug device of claim 3, wherein the stack of circumferential ribs is tapered, bottom to top, from a rib of lesser diameter to rib of greater diameter so that the body seats flexibly into and seals a consumer-supplied bottle neck with the channel open.

8. The bottletop plug device of claim 3, wherein the stack is tapered so that the device is self-seating in a narrow-neck bottle.

9. The bottletop plug device of claim 3, wherein the stack of circumferential rib members comprises a stack having two, three, four, five or six circumferential rib members in a tapered stack.

10. The bottletop plug device of claim 1, wherein the body is of a resilient polymeric material.

11. The bottletop plug device of claim 1, wherein the body is of a silicone rubber.

12. The bottletop plug device of claim 1, wherein at least a part of the body is colored yellow or orange.

13. The bottletop plug device of claim 1, further comprising a narrow-neck bottle or container with an inside-neck surface and diameter configured to accept the bottom end and to sealingly contact at least one of the plurality of laterally protruding seal members against the inside wall of the bottle or container, the combination of device and bottle or container defining an insect trap assembly, and further wherein the bottle may be a consumer-supplied bottle that is reusable after cleaning or disposable with the contents of the trap.

14. A method for using a bottletop plug device to trap flying insects, which comprises:
a) supplying a bottletop plug device, the bottletop plug device having a body with widemouth open top defined by a top lip of the device, an internal conduit chamber fluidly connecting the widemouth open top to an insect-sized bottom orifice at the bottom end of the device, a plurality of laterally protruding seal members intermediately disposed on the device body, the seal members defining a stack of seal members; and,
b) instructing a user to press fit the bottom end of the body of the bottletop plug device into the mouth of a narrow-necked bottle so as to form a seal between at least one of the seal members and an inside surface of the mouth of a narrow neck bottle, the narrow-necked bottle to be supplied by the user.

15. The method of claim 14, comprising giving an instruction to a user to bait the bottle before inserting the device.

16. The method of claim 14, the stack of seal members having a bottom circumferential rib of lesser diameter and an uppermost circumferential rib of greater diameter for flexibly sealing the device against the inside walls of the bottle neck after baiting the bottle.

17. The method of claim 14, the stack of seal members having a plurality of circumferential ribs of essentially the same diameter.

18. The method of claim 14, comprising giving instructions to remove the plug device for reuse and to discard the bottle with any contents or to clean the bottle for reuse.

19. The method of claim 14, comprising giving instructions to a consumer to bait the bottle with a bait selected from fruit, yeast, beer, banana, wine, or vinegar.

20. The method of claim 14, comprising giving instructions to a consumer on how to catch fruit flies with the device.

21. The method of claim 20, comprising giving instructions to a consumer to reuse the device as part of an insect trap assembly.
